(19) United States
(12) Patent Application Publication
(10) Pub. No.: US 2021/0102318 A1
(43) Pub. Date: Apr. 8, 2021

(54) METHOD FOR PRODUCING A TEXTILE OBJECT HAVING ELECTROSTATICALLY CHARGED FIBRES, AND TEXTILE OBJECT

(71) Applicant: Groz-Beckert KG, Albstadt (DE)

(72) Inventors: Ralph Berkemann, Tailfingen (DE); Fabian Stauss, Hechingen (DE); Frank Endriss, Winterlingen-Harthausen (DE)

(21) Appl. No.: 17/041,086

(22) PCT Filed: Mar. 19, 2019
(86) PCT No.: PCT/EP2019/056778

§ 371 Date: Sep. 24, 2020

(30) Foreign Application Priority Data
Apr. 6, 2018 (DE) 10 2018 108 228.2

(51) Int. Cl. D04H 1/4282; D01D 5/04; D01D 5/08; D02J 1/16

(52) U.S. Cl. CPC D04H 1/4282; D01D 5/04; D01D 5/08; D02J 1/16; D10B 2321/022; D10B 2401/16; D10B 2321/121; D10B 2331/02; D10B 2331/061; D10B 2331/10; D10B 2321/041

(57) ABSTRACT

The invention relates to a method for the production of a textile object having electrostatically charged fibres and to a textile object. A die arrangement comprising at least two separate dies or a multipolymer die is used for the production of fibres from different polymers, whereby the polymers are spaced sufficiently apart in a triboelectric series. During the process, the fibres produced from the polymers are co-mingled, at least in sections, and charged triboelectrically. Alternatively or in addition, the fibres are charged triboelectrically by means of an uncomplicated finishing process. Filters with quality factors greater than 0.2 can be produced with the textile object.

The invention relates to a method for the relatively uncomplicated production of a preferably pleated textile object having electrostatically charged fibres, and to a textile object preferably produced by way of the method according to the invention. The textile object is used mainly as depth-filter material. Filters in which such depth-filter material is used are usually characterised by very good filtration properties.

Methods by which filter materials having electrostatically charged fibres may be produced are known from the prior art. Charging the fibres electrostatically can significantly improve the filtration efficiency of filtration materials, in particular with regard to fine particles. This is because particles that merely come near to electrostatically charged fibres can be attracted by their electric field and consequently held back by the filter, whereas the particles in question would not have been held back in the case of an uncharged fibre. The mechanical filtration principle according to which fine particles can only be filtered out by means of fine fibres accordingly needs amending: fine particles can also be filtered out by means of electrically charged coarse fibres.

One known method of charging the fibres of filter materials electrostatically is to charge the fibres concerned by means of corona discharge. However, the currently known methods using a corona discharge do not permit sufficiently potent/effective electrostatic charging of the fibres.

According to another method, fibres are charged with the help of the Lenard effect (Hydrocharging; see EP 2 609 238 B1), using electrically charged water droplets. However, the method is relatively expensive because the fibrous webs produced normally have to undergo tedious drying.

U.S. Pat. No. 8,372,175 B2 discloses a method for producing a filter material, in which coarser fibres are produced by means of a spunbonding process and finer fibres by means of a meltblown process and the two fibre types co-mingle during the production process. Following production of the nonwoven, its fibres may be electrostatically charged, e.g. by means of corona discharge or what is known as hydrocharging. The customary low filament speeds characteristic of spunbonding processes differ distinctly from the high filament speeds typical of meltblown processes, i.e. the filament speeds differ strongly from one another. Furthermore, the sizeable air speeds in the meltblown process can have a considerable negative influence on the filament array. Very strong turbulence is therefore likely to occur during fibre co-mingling, preventing the production of high-quality, uniform nonwoven fabrics having electrostatically charged fibres with this method.

In addition, EP 0 705 931 A1, DE 10 2004 036 440 A1, WO 2006/049664 A1 and the non-published WO 2018/065014 A1 describe methods in which at least two different kinds of polymers are spun to form two different fibre types. At the end of the spinning process, the two fibre types are jointly processed to a non-woven. Frictional interaction between the two fibre types is inevitable during such processing and is accompanied by the random occurrence of triboelectric charging. However, in the absence of a process control means and a material choice which is selectively geared to intensive and lasting triboelelectric charging, the fibres of the nonwovens cannot be intensively and lastingly triboelectrically charged. In consequence, alone for the reason of the randomly occurring triboelectric effect, none of the methods described are suitable for the production of high-quality filters, in particular of filters having a quality factor in excess of 0.2.

Lastly, a method is known from EP 1 208 900 A1, in which staple fibres consisting of at least two different polymers are mixed and then carded or needled. The fibres are charged triboelectrically in this way. Prior to carding and needling the staple fibres, however, the conditioning agents have to be removed at relatively high cost. A further disadvantage is that only relatively coarse fibres can be used in this method. Yet another drawback is that the holes formed by carding and, in particular, by needling, have a negative effect on the filter properties.

The aim of the invention accordingly consists in finding a method which enables the production of textile objects, preferably intended for use as filter material for an electret filter, whose fibres can be semipermanently electrostatically charged during the production process and/or by means of a suitable, uncomplicated finishing process.

The method of producing electrically charged textile objects is carried out using a die arrangement comprising at least two separate dies. Alternatively, use may be made of at least one die with which at least two different polymers can be spun (generally referred to as a multipolymer die). The method is preferably carried out with precisely two dies or precisely one multipolymer die with which precisely two polymers can be spun. For special applications, however, it is also possible to use three or more dies or one multipolymer die and additional dies (of an arbitrary number).

Dies with a linear arrangement of orifices, also referred to as Exxon-type orifices, are known (hereinafter: Exxon dies). Dies which have concentrically arranged orifices are also known (hereinafter: dies with concentric orifices). Biax dies (named after the manufacturer) have a special configuration of concentric orifices.

In each case, a melt spinning process known from the prior art, typically a meltblown spinning process such as a Spun-Blown® or BIAX spinning process, or, alternatively, a solvent spinning process such as a solution blowing process, an electroblowing process, an electrospinning process or a centrifugal spinning process will be carried out with the dies. It is possible to carry out the same kind of spinning process with all the dies or a different kind of spinning process with each die.

In cases where dies are used with which only one polymer can be spun in each case, the first die preferably has concentric orifices, e.g. of the Biax type, but may also have a linear arrangement of orifices (Exxon type). As the second die (and maybe a third/additional die(s)), use may be made optionally of a die with a linear arrangement of orifices (Exxon-type) or concentric orifices, e.g. of the Biax-type. Alternatively, as each of the first, second and maybe additional dies, a die for solvent spinning processes may be used, such as a solution blowing process, an electroblowing process, an electrospinning process or a centrifugal spinning process (either alone or in combination).

During meltblown spinning processes (melt blowing), a polymer melt is forced through the capillary openings of a die. As the polymer exits from the capillary openings, it is caught up in a stream of gas, usually an air stream, moving at very high speed. The exiting polymer is dragged by the gas stream and drawn to polymer fibres with substantially smaller diameters than the diameter of the molten polymer directly after it exits from the capillaries. Melt blowing produces relatively long thread lengths (i.e. relatively long fibres). However, compared with spunbonding processes, considerably more filament breaks may occur.

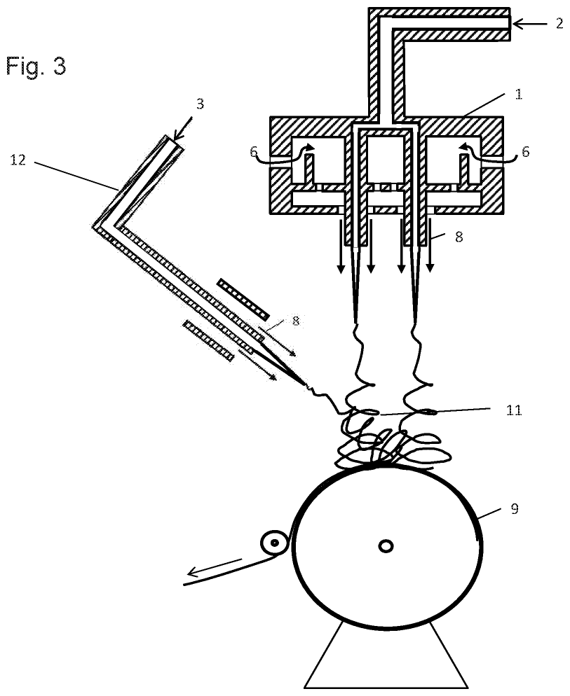

Alternatively, a spinning process with a die devoid of holes may be used, as is described, for example, in U.S. Pat. No. 7,628,941 B2 (Polymer Group, Inc, later Avintiv Specialty Materials Inc) in FIGS. 3 to 5.

In solvent spinning processes, a solution of a polymer in a solvent is spun instead of the melt. Except for this difference, the solution blowing process, the electroblowing process, the electrospinning process and the centrifugal spinning process are carried out in largely the same way as the meltblown spinning processes.

To carry out the method, the melt or, alternatively, the solution of a first polymer, is spun to fibres of a first fibre type with the aid of the first die. With the aid of (at least) one second die, the melt or, alternatively, the solution of (at least) one second polymer is spun to fibres of (at least) one second fibre type. Where required, a third polymer is spun to fibres of a third fibre type by means of a third die. Additional polymers may be spun to form fibres of additional fibre types by means of additional dies. Alternatively, use is made of a multipolymer die with which two or more different polymers can be spun. Analogously, it is also possible to make use of further multipolymer dies and/or of further dies with which only one polymer can be spun.

The textile object according to the invention is shaped from the fibres of all the fibre types, at least, however, from the fibres of the first fibre type and the fibres of the second fibre type, by means of a collecting device. According to the invention, the polymer for production of the first fibre type, the polymer for production of the second fibre type and, as the case may be, the polymers for production of further fibre types, are selected such that the fibres spun from these (at least) two different polymers can be charged so effectively by means of triboelectric effects between the (at least) two different fibre types that, provided the process parameters and, where applicable, the finishing methods are selected suitably, filters with quality factors in excess of 0.2 can be made with the textile objects produced. It generally suffices if exclusively triboelectric methods are used to impart the electrical charge.

A polymer containing at least one additive capable of binding free radicals and/or containing at least one additive capable of acting as internal slip agent is used as the first polymer and/or as the at least one second polymer. The additives, singly or preferably in combination, enable a more intensive and longer-lasting, normally semi-permanent, triboelectric charge to be imparted to the fibres of the textile object. Provided at least two fibre types having different average fibre diameters are present in the textile object produced, a preferred variant uses a polymer containing at least one of the above-described additives (i.e. an additive capable of binding free radicals and/or an additive capable of acting as an internal slip agent) for one fibre type, which has a smaller average fibre diameter than the fibre type with the largest average fibre diameter. According to this variant, the fibre type containing the additive may either be the one with the smallest average fibre diameter or, if more than two fibre types are present, also any other fibre type that is not the one with the largest average diameter.

For the sake of simplicity, the description hereinafter always refers to two different fibre types, which can be electrically charged by means of triboelectric effects. According to a preferred variant, precisely two different fibre types are used. However, this should not be construed as a limitation of the invention to the effect of ruling out the use of three or more fibre types, e.g. consisting in each case of different polymers, which, preferably in combination, can be particularly intensively and/or lastingly charged by means of triboelectric effects.

The frictional interaction intended to bring about triboelectric charging may occur before and/or during shaping of the textile object. Triboelectric charging may occur during the spinning process and/or on deposition of the textile object on a suitable collecting device/deposition device such as a collecting belt or a collecting drum. Alternatively, or in addition, the frictional processes in question may be induced by subjecting the textile object already produced to a finishing process. The finishing process may produce significant, as yet non-existent, triboelectric charging or else reinforce an already existing triboelectric charge.

During spinning of one polymer (to fibres of one fibre type) and of at least one other polymer (to fibres of at least one other fibre type), it is furthermore preferable to select the process parameters such that the fibres of the one fibre type have a larger average fibre diameter than the fibres of the at least one other fibre type.

Where a so-called bimodal nonwoven of this kind is used as filter material, the finer fibres serve to separate out particularly the finer particles, i.e. to enhance the filtration efficiency with respect to finer particles. The coarse fibres serve, firstly, to filter out coarser particles and, secondly, to impart sufficient mechanical stability to the bimodal nonwoven. This arrangement also ensures that in a nonwoven of this kind, the finer fibres are sufficiently spaced apart from each other on account of their being mixed with coarse fibres. In a nonwoven consisting exclusively of finer fibres, the fine fibres would be too close together, i.e. when used in a filter, a nonwoven of this kind would cause too great a differential pressure and the filter would always block very quickly when filtering dust or a particle-containing medium.

The one fibre type and the at least one other fibre type, by means of which the mechanical structure of the textile fabric is formed, and the fibre types which are formed from the first polymer and from the at least one second polymer and which determine the triboelectric properties of the textile object may be identical in each case. In particular, the first fibre type and the one fibre type may be identical and, simultaneously, the at least one second fibre type and the at least one other fibre type may be identical. Or the first fibre type and the at least one other one other fibre type may be identical and, simultaneously, the at least one second fibre type and the one fibre type may be identical. In this way, the mechanical and triboelectrical properties coincide in each case, i.e. the coarse and fine fibres consist of different polymers, which can also acquire triboelectric charge.

Alternatively, each of the fibre types may differ partially or wholly from one another. In an alternative variant it is possible, for example, for the one fibre type and the first fibre type to be identical while the at least one other fibre type is spun to a further (third) fibre type by means of at least one additional (third) die and differs from the second fibre type. In this way, it is possible to produce a textile object that consists of a framework of coarse, largely electrically uncharged fibres and two, as a rule thinner, fibre types that can acquire a good amount of triboelectric charge.

In order that the fibres spun from the two polymers can acquire a good, or at least a satisfactory, amount of charge, the first polymer and the at least one second polymer must normally be spaced sufficiently apart in a triboelectric series. However, most triboelectric series do not quantify the triboelectric properties of the substances listed but merely sort them into a sequence. If two substances are far apart in a triboelectric series of this kind, this indicates that they will build up a notable charge if rubbed against each other. However, no quantitative information is possible.

One of the few tables in which the triboelectric properties of the substances listed are assigned a quantitative value is the table shown below (copyright 2009: AlphaLab, Inc.; Trifield.com). Each substance in the table is assigned a numerical value which describes how strongly and with what polarity the substance becomes charged if rubbed against a reference substance with a defined energy input. A substance with a positive value becomes positively charged and a substance with a negative value becomes negatively charged. The numerical value is known as “charge affinity” and this term will be used hereinafter. Charge affinity has the unit nC/J and is usually expressed in nano amp sec/watt sec.

The table has an additional column which contains a correction factor: W (weak) means that the acquired triboelectric charge is weaker than would be expected from the charge affinity value; N (normal) means that the acquired charge is as expected. The original table contains a further column which shows the conductivity of each substance. This column had to be omitted in order to save space. The exact measuring conditions for determining charge affinity are available at https://www.trifield.com/content/tribo-electric-series/. For substances not contained in the table, the suggestion is to use the charge affinity values which would be determined using the measuring procedure described in detail at www.trifield.com or which, alternatively, would be determined using a similar measuring procedure which, allowing for measuring tolerances, provides the same values.

TABLE 1
Various substances and their charge affinities
(copyright 2009 AlphaLab, Inc.)

| | | |
|---|---|---|
| Polyurethane foam | +60 | +N |
| Sorbothane | +58 | −W |
| Box sealing tape (BOPP) | +55 | +W |
| Hair, oily skin | +45 | +N |
| Solid polyurethane, filled | +40 | +N |
| Magnesium fluoride (MgF2) | +35 | +N |
| Nylon, dry skin | +30 | +N |
| Machine oil | +29 | +N |
| Nylatron (nylon filled with Mofo) | +28 | +N |
| Glass (soda) | +25 | +N |
| Paper (uncoated copy) | +10 | −W |
| Wood (pine) | +7 | −W |
| GE brand Silicone II (hardens in air) | +6 | +N |
| Cotton | +5 | +N |
| Nitrile rubber | +3 | −W |
| Wool | 0 | −W |
| Polycarbonate | −5 | −W |
| ABS | −5 | −N |
| Acrylic (polymethyl methacrylate) and adhesive side of | −10 | −N |
| clear carton-sealing and office tape | | |
| Epoxy (circuit board) | −32 | −N |
| Styrene-butadiene rubber (SBR, Buna S) | −35 | −N |
| Solvent-based spray paints | −38 | −N |
| PET (mylar) cloth | −40 | −W |
| PET (mylar) solid | −40 | +W |
| EVA rubber for gaskets, filled | −55 | −N |
| Gum rubber | −60 | −N |
| Hot melt glue | −62 | −N |
| Polystyrene | −70 | −N |
| Polyimide | −70 | −N |
| Silicones (air harden & thermoset, but not GE) | −72 | −N |
| Vinyl: flexible (clear tubing) | −75 | −N |
| Carton-sealing tape (BOPP), sanded down | −85 | −N |
| Olefins (alkenes): LOPE, HOPE, PP | −90 | −N |
| Cellulose nitrate | −93 | −N |
| Office tape backing (vinyl copolymer ?) | −95 | −N |
| UHMWPE | −95 | −N |
| Neoprene (polychloroprene, not SBR) | −98 | −N |
| PVC (rigid vinyl) | −100 | −N |
| Latex (natural) rubber | −105 | −N |
| Viton, filled | −117 | −N |
| Epichlorohydrin rubber, filled | −118 | −N |
| Santoprene rubber | −120 | −N |
| Hypalon rubber, filled | −130 | −N |
| Butyl rubber, filled | −135 | −N |
| EDPM rubber, filled | −140 | −N |
| Teflon | −190 | −N |

Preferably, the first polymer and the at least one second polymer are selected such that the difference between the charge affinity of the fibres of the fibre type formed from the first polymer and the charge affinity of the fibres of the fibre type formed from the at least one second polymer is at least 15 nC/J, at least 30 nC/J, at least 50 nC/J, at least 70 nC/J, at least 85 nC/J, at least 100 nC/J or at least 115 nC/J. Alternatively, the first polymer and the at least one second polymer may be selected such that the difference in charge affinity between the first and the at least one second polymer is at least 15 nC/J, at least 30 nC/J, at least 50 nC/J, at least 70 nC/J, at least 85 nC/J, at least 100 nC/J or at least 115 nC/J. The charge affinities of the fibres are namely difficult to determine, but they approximate closely to the charge affinities of the polymers from which they are made. By “difference in charge affinities” a positive numerical value is always to be understood, i.e. the absolute value of the difference between the two charge affinities.

At least one of the polymers polypropylene, polyactide, polystyrene, polyvinyl chloride or a blend of these polymers may be used advantageously for the production of one of the fibre types, preferably for the production of a fibre type which does not have the largest average fibre diameter. These polymers are characterised by comparatively negative charge affinities (with a high absolute value). The fibre type produced from the aforementioned polymers preferably has the smallest average fibre diameter.

A polyamide (e.g., nylon), polyurethane, cellulose, polycarbonate, a synthetic resin, polybutylene terephthalate, polyethylene terephthalate, PVDF POM, PEEK, PAN, PMMA, melamine or a blend of these polymers may be used advantageously for the production of one of the fibre types, preferably for the production of a fibre type which does not have the smallest average fibre diameter. These polymers are characterised by comparatively high, positive charge affinity values. The fibre type produced from the aforementioned polymers preferably has the largest average fibre diameter.

With a suitable combination of the first polymer and the at least one second polymer, e.g. if the difference between the charge affinity values of the two polymers is comparatively great, and with a suitable arrangement of the dies, it is possible to achieve triboelectric charging of the polymer fibres by means of frictional processes occurring during production of the textile object.

In a preferred variant, polypropylene is used as the first polymer and a polyamide as the second polymer. In this connection, it has proved advantageous if at least the polypropylene contains an additive capable of binding free radicals and/or an additive capable of acting as internal slip agent. It has also proved advantageous if the fibre type spun from the polypropylene has a smaller average fibre diameter than the fibre type spun from the polyamide.

One reason for the occurrence of triboelectric charging during fibre spinning may be seen in the so-called “whipping” effect, which practically always occurs during meltblown spinning processes with high fibre speeds. The whipping effect is characterised in that, at a certain distance from the associated die, the fibres perform a sort of reeling or whipping movement, i.e. they do not move directly away from the associated die and towards the collecting device but also perform rapid and pronounced transverse movements. If the dies are arranged such that the fibres of the first type (consisting of a first polymer) co-mingle with the fibres of the (at least one) second type (consisting of a second polymer) after a relatively short distance, i.e. long before the fibres reach the collecting device, the whipping effect causes intensive frictional interaction between the two fibre types during the spinning and deposition process (in-situ, i.e. before the fibres of the first type and the fibres of the (at least one) second type reach the collecting device.

A “relatively short distance” in connection with the distance at which the two fibre types co-mingle at least partially for the first time is understood to be a maximum distance of 2 cm, a maximum of 5 cm, a maximum of 10 cm or a maximum of 15 cm between the point at which the two fibre types co-mingle at least partially for the first time and the more distant of the two dies used for spinning the one polymer and the at least one other polymer. This die will be referred to hereinafter as the more distant die. By analogy, a distance between the mingling point and the more distant die which is a maximum of 5%, a maximum of 10%, a maximum of 20%, a maximum of 30% or a maximum of 50% of the distance between the collecting device and the more distant die may also be deemed a relatively short distance.

Alternatively or in addition, the electret properties of the textile object may be improved (or maybe activated in the first place) after the spinning and deposition process by causing, inline or offline, the fibres consisting of the first polymer and the fibres consisting of the at least one second polymer to rub mechanically against each other.

Alternatively, or in order to enhance the in-situ charging described hereinbefore, the filaments may be energized, e.g. with a higher frequency, mechanically and/or pneumatically and/or by a (pulsed) electric field. For this purpose use might be made, e.g., of a pulsed air stream and/or energization by means of ultrasound. In addition, methods may be used which are already known from the prior art and serve to improve the uniformity of nonwovens.

It was found that triboelectric charging can be reinforced particularly well by subsequently exposing the textile objects produced to high-frequency sound/ultrasound. Sound waves with a frequency greater than 1 kHz, greater than 10 kHz or greater than 15 kHz may be used for this purpose. Sound waves with a frequency of 1 kHz to 100 kHz, with a frequency of 5 kHz to 50 kHz or with a frequency of 15 kHz to 25 kHz may be used for purposes of acoustic irradiation. Particularly good triboelectric charging was achieved with frequencies of approx. 20 kHz. The duration of acoustic irradiation may range from one second to 30 minutes, preferably 10 seconds to 10 minutes, or, best of all, from 30 seconds to 3 minutes. Particularly good results, which involved little effort and expense, were obtained with an acoustic-irradiation duration of approx. 1 minute.

Textile objects, in particular nonwovens, having relatively little structural integrity, i.e. in which the fibres, at least the finer fibres, have relatively small average fibre diameters, proved especially suitable for treatment with sound/ultrasound, which is preferably performed as a finishing process. Fibres with larger diameters cool down more slowly, the consequence being that on formation of the textile object, normally the formation of a fibrous web by deposition on a collecting device, they adhere together better (or adhere together in the first place) than fibres with smaller diameters. In order to achieve good triboelelectric charging of the textile object by way of subsequent acoustic irradiation, it is advantageous if at least some of the fibres or at least some of the fibre types remain as mobile as possible. Weak inter-fibre adhesion is of no consequence provided the bonds concerned can be undone again subsequently through the influence of sound/ultrasound.

It is possible in this context to select fibre types which are all sufficiently fine to allow practically all the fibres to remain mobile, i.e. frictional interaction occurs primarily between moving fibres. Alternatively, some of the fibres selected may be coarser, in which case at least most of these coarser fibres adhere together. It was found that in a combination of this kind only the coarse fibres adhere together but hardly any of the fine fibres adhere to the coarse fibres. In this case, therefore, frictional interaction occurs primarily between a practically stationary framework of coarse fibres and fine, moving fibres.

This means that if textile objects are to be pleatable, their structural integrity should normally be just sufficient to make this possible. The average fibre diameters of the coarsest fibre type are then typically 5 μm to 50 μm, preferably 8 μm to 25 μm and, best of all, 10 μm to 15 μm. In the case of textile objects that need not be pleatable, the average fibre diameter of the coarsest fibre type may be smaller still, e,g. 0.2 μm to 10 μm, 0.5 μm to 5 μm or 1 μm to 3 μm.

In order to improve the electret properties (or maybe to activate them in the first place), the finished textile object may also be fulled or kneaded, e.g. by pulling it through a loop or eyelet. The textile object may also be drawn or, e.g. impacted by means of a felting process. In addition, the textile object may be expanded and/or relaxed (preferably cold and in the absence of moisture), e.g. during shrinking/sanforization. A further method of making fibres vibrate or perform other movements, thereby triggering frictional interaction, consists in exposing the textile object to vibrations or acoustic irradiation, e.g. by means of ultrasound. It is also possible to improve the textile object's electret properties by passing gases or vapours through it.

In addition, auxiliary prior-art methods for the electrical charging of fibres in situ may be used, e.g. hydrocharging or a corona discharge.

It is also conceivable to set the fibres of the filters made from the textile object of the invention in vibration, or to make them move in other ways, while the filter is in use or during maintenance intervals, and to do this in such a way that the fibres contained in the filter (particularly the fibre pairs made of different substances) rub against each other and are thus recharged triboelectrically. While the filter is in use, a suitable (e.g. a turbulent) air supply may be generated for this purpose, and/or the filter exposed to acoustic irradiation or vibration. During maintenance intervals, all the other methods for recharging fibres triboelectrically, which were described in the preceding paragraph in connection with the finishing of (newly produced) textile objects, may be used.

The method of the invention thus makes it possible to produce textile objects, the fibres of which are potently/effectively electrostatically charged, in a single-step process that may be combined if necessary with a comparatively simple finishing process. The (pleatable) textile object according to the invention accordingly consists of fibres which are produced using a melt spinning process or a solvent spinning process. The fibres are made up of a first fibre type consisting of fibres of a first polymer, and (at least) a second fibre type consisting of fibres of a second polymer. The fibres produced from the first polymer and/or the fibres produced from the at least one second polymer can be so strongly charged triboelectrically by frictional interaction occurring before and/or during shaping of the textile object and/or by frictional interaction occurring during a finishing process that the textile object may be used to manufacture filters with quality factors in excess of 0.2. The first polymer and/or the at least one second polymer contains at least one additive capable of binding free radicals and/or an additive capable of acting as internal slip agent.

Use of the textile object as filter material enables the production of improved filters showing high filtration efficiency and high particle-holding capacity (high dust-holding capacity in the case of air filters). The textile object may also contain fibres with a largish average diameter (coarser fibres) and with a smallish average fibre diameter (finer fibres). The diameter of the coarser fibres may be selected such that they are large enough to enable the filter material (nonwoven material) to be used without substrates, e.g. spunbonded nonwovens. In particular, quality factors in excess of 0.2 are achievable. The quality factor QF is defined as

QF=(−ln(DEHS penetration/100))/differential pressure in mm H₂O).

The “DEHS penetration” (penetration factor of an uncharged filter) and also the differential pressure may be determined accurately, e.g. with a Palas MFP 3000 test rig, at a flow-through speed of 0.1 m/s.

The collecting device is preferably a transport belt or a transport drum equipped with a suction means. The fibres of the first and of the (at least) second fibre type are sucked by the suction means of the transport belt or transport drum and deposited together on the transport belt/drum.

The textile object comprising the fibres of the one fibre type and the fibres of the at least one other fibre type are generally shaped by means of the collecting device in such a way that, before and/or during collection of the fibres, e.g. by depositing the fibres on a collecting belt or a collecting drum, co-mingling of the two (or more) fibre types takes place. The textile object is shaped by collection of the fibres. In the finished textile object, the fibres of the one fibre type are co-mingled, at least in sections, with the fibres of the at least one other fibre type. Such sections may be so small, however, that virtually two (or three or more in cases where three or more dies are used) discrete layers exist, which are only held together by a very thin co-mingling zone.

Preferably, the process parameters, e.g. the angle between the spinning directions of the dies for the one fibre type and for the at least one other fibre type, or the way in which these dies and the associated collecting device are otherwise spatially arranged, are selected such that, at least in a portion of the textile object produced, the proportions of fibres of the one fibre type and of the at least one other fibre type are graded. This portion preferably extends over at least 50%, 90% or 98% of the volume of the textile object.

If the textile object is a nonwoven intended for use as depth filter material for an electrostatically charged filter medium, the gradient is preferably designed such that, on the side of the nonwoven which, in the filter, is intended for the upstream flow, the proportion of coarser fibres is higher than the proportion of finer fibres, and, on the side intended as the clean-air side, the proportion of finer fibres is higher than the proportion of coarser fibres. With this arrangement, a large proportion of coarse particles is already retained in the coarse-fibre zone while the finer particles are retained predominantly in the zones in which the proportion of finer fibres is relatively high. This ensures that zones in which the proportion of finer fibres is relatively high are not quickly blocked with coarse particles. Thanks to the graded distribution of fibre-diameter size, interfaces with large differences in fibre diameter, at which particles tend to accumulate and ultimately cause blockages, are avoided. In consequence, almost the entire cross section of the structure is used for filtration.

If a nonwoven according to the invention is used for the production of a pleated filter, a manufacturer will be able to select, as depth filter material, a thinner nonwoven which, however, has the same particle- or dust-holding capacity as a thicker, conventionally manufactured nonwoven. In the case of pleated filters, the folds or crests of the pleats do not contribute to filtration or do so only minimally. Consequently, the filtration effect of filters made from the thin nonwovens according to the invention is better than that of filters made from thicker nonwovens. This is because the surface area of the fold/crest of the pleats, which is ineffective for filtration, is smaller in the case of thinner nonwovens than in the case of thicker nonwovens.

The fibres of the one fibre type, i.e. the coarser fibres, are preferably spun such that the average value of the fibre diameter is greater than 10 μm, greater than 15 μm, greater than 25 μm or greater than 50 μm. The average value of the fibre diameters may lie in a range from e.g. 2 μm to 200 μm, 5 μm to 60 μm or 10 μm to 30 μm. The average value of the fibre diameters is preferably in the range from 5 μm to 60 μm.

The fibres of the at least one other fibre type, i.e. the finer fibres, are preferably spun such that the average value of the fibre diameter is less than 11 μm, less than 5 μm or less than 3 μm. The finest fibres of the second fibre type may have minimum diameters as small as 20 nm. The fibres in question are preferably produced using a solvent spinning process.

It is intended that the average diameters of the two fibre types then be far enough apart for the two maxima to be distinctly recognizable in the overall distribution of fibre diameters. A fibre distribution of this kind is referred to as a “bimodal fibre distribution”.

In order to obtain a bimodal fibre-diameter distribution of this kind, use may be made of one die with orifices ranging from 500 to 850 micrometers and of another die with orifices ranging in diameter from 100 to 500 micrometers.

For carrying out the method of the invention, it proved of value generally to select (as one and as at least one other polymer for the fibres of one and of at least one other fibre type) polymers that have melt flow indices (hereinafter: MFI) lower than 1000, lower than 500 or lower than 300. The MFI should, if possible, be determined as per ISO 1133. Otherwise, it should be determined as per ASTM D1238. The table below lists further standard conditions for various polymers. If neither of the two standards nor the table contain standard parameters for determining the MFI of the polymer in question, reference should be made to existing tables such as the DIN paperback “Thermoplastische Formmassen” (thermoplastic moulding materials) the CAMPUS database or the spec sheets supplied by the manufacturer of the particular polymer. Since a plurality of parameter sets, in particular a plurality of test temperatures and/or test loads, are often listed for determining the MFI of one and the same polymer, the parameter set with the highest temperature should always be selected in such a case, and maybe the parameter set which, in addition to the highest temperature, also lists the highest test load.

TABLE 2
Standard parameters for measuring the MFIs of various polymers

| Test | | | | | | | |
|---|---|---|---|---|---|---|---|
| temper- | Test load/kg | | | | | | |
| ature/° C. | 0.325 | 1.2 | 2.16 | 3.8 | 5 | 10 | 21.6 |
| 125 | EVA | | | | | | |
| 150 | | | EVA | | | | |
| 190 | | | PE | | PE | | PE |
| | | | EVA | | PP | | WPC |
| | | | POM | | | | |
| 200 | | | | | PS | | |
| 220 | | | | | | ABS | |
| | | | | | | SAN | |
| | | | | | | ASA | |
| 230 | | | PP | PMMA | PP | | |
| | | | | | PVDF | | |
| 235 | | | PA-12 | | PA-12 | PA-11 | |
| | | | PA-11 | | PA-11 | | |
| 250 | | | PBT | | | | |
| 260 | | | PBT | | PMP | PMMI | |
| 275 | | | | | PA | | |
| 280 | | PPE/PS | PET | PPE/PS | PPE/PS | | |
| | | | PPE/PS | | | | |
| 300 | | PC | PPE/PS | | PA-GF | PPE/PS | |
| | | | | | PPE/PS | | |
| 315 | | | | | PPS | | |
| 330 | | | PC | | | PA6T | |
| 340 | | | PC | | | PEI | |
| 343 | | | PSU | | | | |
| 360 | | | | | | PES | |
| | | | | | | PPSU | |
| | | | | | | PSU | |
| 400 | | | PES | | | | |
| | | | PPSU | | | | |
| | | | PEEK | | | | |

Particularly intensive and long-lasting static charging may be achieved by using, as first and/or as second polymer, a polymer containing at least one additive that is able to bind free radicals, i.e. a so-called free-radical scavenger. As free-radical scavenger, use may be made, e.g., of a substance from the group of sterically hindered amines (HALS: Hindered-Amine Light Stabilizers), e.g. the amine known by its trade name Chimasorb® 944. As an alternative to the HALS, substances from the group of piserazines or from the group of oxazolidones may also be used.

It also proved of value to use at least one polymer that contains at least one additive, for example a substance from the group of stearamides, that may act as internal slip agent (migration aid). Ethylene distearamide (generally known as ethylene bis(stearamide) (EBS) and also by the trade name Crodamide® EBS), proved particularly suitable.

It is preferable to use polymers containing at least one of the above-mentioned additives that can act as free-radical scavenger and simultaneously at least one of the additives described above that can act as internal slip agent. These additives were observed to be particularly effective in combination with polypropylene.

The substances acting as free-radical scavengers are able to bind electrostatic charges for a comparatively long period of time. The effect of the internal slip agents is that substances that are able to bind charges in the long term, when contained in a molten polymer, are able to move more easily to the surface of the polymer. Since electrostatic charging always occurs at the surface, a larger proportion of these substances is available for binding the electrostatic charges. The substances in question have practically no effect if they are in the interior of the polymer (of the polymer fibre).

Additionally, at least one polymer may be used which contains at least a further additive such as a ferroelectric ceramics material (e.g. barium titanate), which is able, e.g. physically, to bind additional charges, or, alternatively, which contains a further additive, which is suitable for preventing charges already present on the fibres concerned from being lost again (i.e. which practically protects the existing charges). Fluorochemicals may be used to advantage for this purpose, e.g. fluorine-containing oxazolidinone, fluorine-containing piperazine or a stearate ester of perfluorinated alcohols.

To further improve the filter, super-fine fibres (i.e. fibres with an average fibre diameter of less than 1 micrometer) may be added to the fibres of the first fibre type and/or to the fibres of the second fibre type. Alternatively or in addition, staple fibres may be added to the fibres of the first fibre type and/or to the fibres of the second fibre type, e.g. by means of a Rando Webber, or particles such as particles of activated charcoal, e.g. by means of a strewing trough or chute.

These additions are effected in the method according to the invention before and/or during shaping of the textile fabric in the collecting device. The super-fine fibres are usually added not as finished fibres/particles but by means of a separate spinning unit, e.g. by means of a solution blowing spinning unit, which generates the super-fine fibres directly before they are added.

The invention is explained in more detail below on the basis of embodiments.

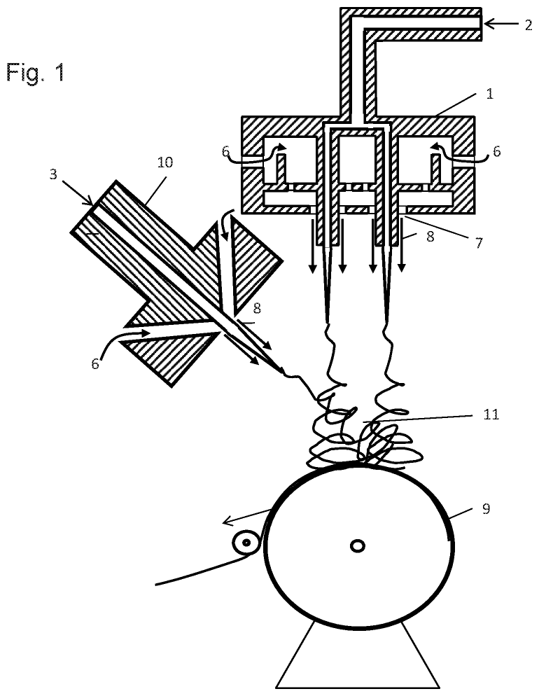

FIG. 1 is a schematic view showing the structure of a melt-blowing facility with a die arrangement consisting of one Exxon and one Biax die.

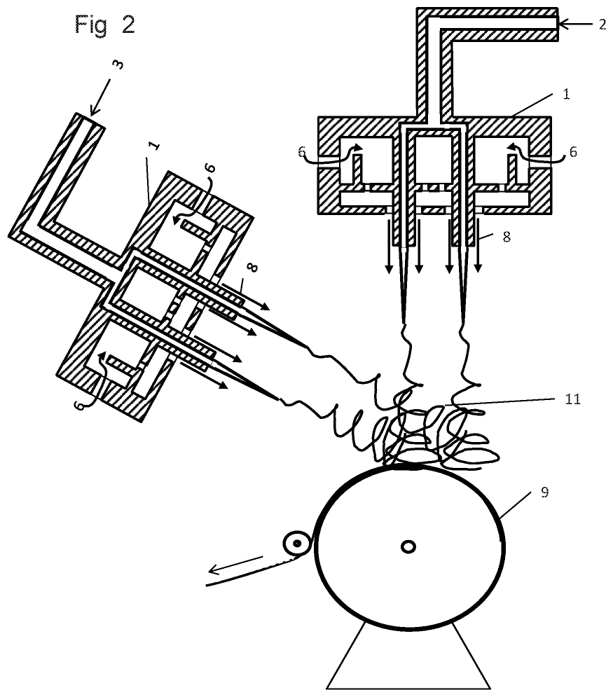

FIG. 2 is a schematic view showing the structure of a melt-blowing facility with a die arrangement consisting of two Biax dies.

FIG. 3 is a schematic view showing the structure of a facility with a die arrangement consisting of one solution-blowing and one Biax die.

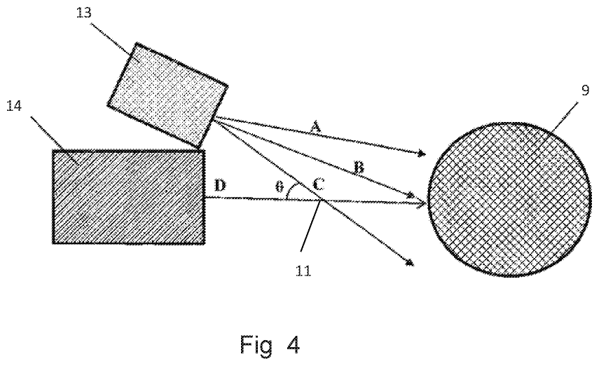

FIG. 4 is a schematic view showing the geometry of a melt-blowing facility having two dies.

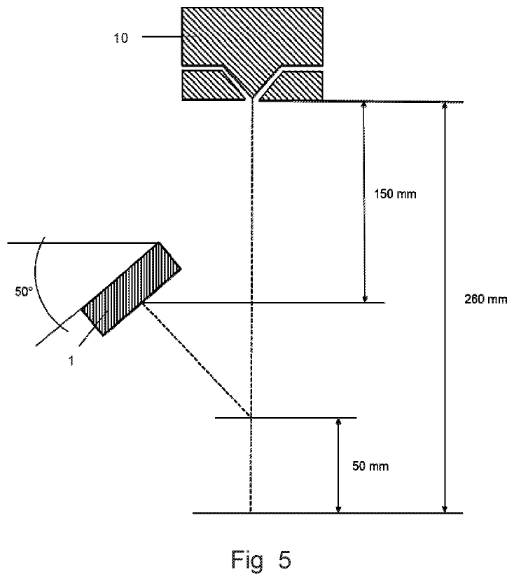

FIG. 5 is a schematic view showing the structure of the facility used in the experiment on the production and ultrasound finishing of a fibrous web.

As is evident from FIG. 1, in the case of the multirow Biax die 1 (of concentric design), a molten first polymer 2 is supplied to the polymer feed line 4 and exits again at the end of the duct 5. In addition, hot compressed air 6 is supplied to the Biax-type orifices of the Biax die 1 and exits again as high-speed blowing air 8 at the outlet 7. The exiting first polymer 2 is caught up by the high-speed blowing air 8, which draws the polymer fibres formed from the exiting polymer 2. The polymer fibres of the polymer 2 are deposited on the collecting drum 9.

The Exxon die 10 is used to spin a second polymer 3, which typically has a charge affinity value that differs greatly from that of the first polymer 2, to polymer fibres. The spinning process carried out with the Exxon die 10 is very similar to the spinning process carried out with the Biax die 1. However, the Exxon die 10, unlike the Biax die 1, is of linear design.

The polymer fibres made of the first polymer 2 and of the second polymer 3 co-mingle for the first time, at least partially, at the co-mingling point 11 on their way to the collecting drum 9. The distance between the co-mingling point 11 and the two dies 1, 10 is not drawn to scale. In reality, it is usually closer to the two dies 1, 10 than shown in the drawings. The frictional interaction occurring during co-mingling causes the polymer fibres to acquire a certain amount of triboelectric charge already in situ. If this triboelectric charging is insufficient, the polymer fibres of the fibrous fleece generated may be subjected to additional triboelectric charging by a mechanical finishing process which causes intensive frictional activity between the polymer fibres (pairwise between the polymer fibres consisting of the first polymer 2 and the second polymer 3.

FIG. 2 shows a similar setup, in which, however, two Biax dies 1 are used. The first polymer 2 is spun to polymer fibres with the one Biax die 1 and a second polymer 3 with the other Biax die 1. FIG. 3 shows an analogous setup, in which a solution-blowing die 12 is used in combination with a Biax die.

FIG. 4 is a schematic illustration of how, in principle, the geometry of a melt-blowing facility having a first die 13 and a second die 14 may be adjusted. In order, firstly, to achieve intensive triboelectric charging of the fibres and, secondly, to selectively adjust the layered structure of the fibrous webs produced with the facility, the axis A, B or C of the second die 14 is first of all tilted by an angle θ relative to the axis D of the first die 13 and/or the distance between the first die 13 and the collecting drum 9 varied. The tilt angle is typically 15° to 60°. In addition, the length of the axis D, i.e. the distance between the first die 13 and the collecting drum 9, may be varied.

In order to obtain high-quality fibrous fleeces, the diameters of the orifice capillaries, the number of orifices, the polymer throughput in each case and the amount of high-speed blowing air must be selected such that a sufficient number of fibres, generally fine and coarse fibres, are spun and, simultaneously, a nonwoven object is produced which is as homogeneous as possible. In order to achieve intensive triboelectric charging of the polymer fibres, the co-mingling point 11 should, on the one hand, be as far as possible from the collecting drum 9. On the other hand, the co-mingling point 11 must not be too far away from the collecting drum 9 because otherwise the quality, in particular the uniformity, of the fibrous webs produced deteriorates.

Suitable parameter selection will generally enable the production of fibrous webs with triboelectrically charged fibres and with a layered structure, with partial co-mingling (gradient structure) of the two fibre types or with thorough co-mingling (largely homogeneous with only little gradient structure) of the two fibre types.

As described in more detail below, pursuit of the essence of the invention has already enabled the production of nonwovens with the help of whose triboelectric charge it was possible to manufacture filters with substantially higher filtration efficiencies and quality factors than filters made from electrically uncharged but otherwise structurally identical nonwovens. In particular, quality factors substantially in excess of 0.2 were achieved with the filters in question.

Use was made of a melt-blowing facility of the kind shown in FIG. 1, i.e. a facility with a die arrangement consisting of one Exxon die 10 and one Biax die 1. The exact geometry of the die arrangement used is shown in FIG. 5. Each of the dies has a separate polymer-melt supply means, in which pellets of the respective polymer are melted in an extruder. The polymer melt was then conveyed to the associated die. Table 3 shows the configuration of the experimental facility used and the processing parameters used.

As is usual with meltblown spinning processes, the fibres produced followed an air stream (aligned in the spinning direction) towards a collecting belt that was equipped with a collecting device. There, the collected fibres formed a nonwoven that was removed and wound up in the direction of the belt's movement. Care was taken that the nonwovens produced possessed only just enough structural integrity, thereby ensuring that as many of the fibres as possible did not adhere, or at least not firmly, to one another but remained mobile or were only so weakly bonded that the bonds were easy to break under the influence of ultrasonic waves. The intention here was to achieve a high level of triboelectric chargeability. During blending of the coarse and fine fibres care was taken, moreover, to obtain a structure with a favourable relation between efficiency and differential pressure. Table 4 lists the basic properties of the nonwovens produced in this way.

TABLE 3

| | No. 1: EXXON | No. 2 Concentric |
|---|---|---|
| Die type | type | type (BIAX) |
| Width | 500 | 500 mm |
| Holes/inch | 7.16 | 25.4 |
| Capillary-Ø | 0.4 mm | 0.2 mm |
| Capillary rows across | 1 | 2 |
| the width | | |
| Polymer | Polyamide PA 6 | Polypropylene |
| | Ultramid B24 N03 | PP HL504FB |
| | (BASF) | (Borealis) |
| Viscosity in RV | RV 2.43 ± 0.03 | MFR 400 |
| (ISO 307)/MFR | | |
| (ISO 1133) | | |
| [g/10 min] | | |
| Additive 1 | — | Chimassorb ® |
| | | 944 (BASF) |
| Amount in the polymer | — | 1.6% |
| Additive 2 | — | Crodamide ™ |
| | | EBS (Croda) |
| Amount in the polymer | — | 1.6% |
| Temperature spinning | 270 | 230 |
| head [° C.] | | |
| Blowing air | 300 | 250 |
| temperature [° C.] | | |
| Air volume | 200 | 730 |
| [Nm³/h] | | |

TABLE 4

| Die type | No. 1: EXXON type | No. 2: Concentric type |
|---|---|---|
| Mass per unit area/die | 14.4 | 10.5 |
| [g/m²] | | |
| Fibre diameter | 12 | 1.5 |
| (median) [μm] | | |

| | |
|---|---|
| Mass per unit area | 24.9 ± 0.9 |
| [g/m²] | |
| ISO 9073-1 | |
| Thickness [mm] | 0.28 ± 0.04 |
| ISO 9073-2 | |

No significant triboelectric charging of the nonwovens produced was achieved by way of the spinning process on its own, at least not with the selected process parameters. However, it is probably possible to select the process parameters in such a way that significant triboelectric charging is already achieved during the spinning process (i.e. inline). Alternatively, or in addition, a sound energy treatment (with optimized sound intensity and duration of acoustic irradiation) may be carried out during the spinning and deposition process in order to achieve triboelectric charging already at the spinning stage.

In the present embodiment of the invention, the nonwovens were not subjected to sound energy treatment until after their production. For this purpose, the nonwovens were irradiated with sound waves having a frequency of 20 kHz for one minute by means of a Visaton G20SC dome tweeter. The dome tweeter was controlled with a Grundig TG4 audio generator. It is also conceivable to use acoustic irradiation of this kind directly during production of the nonwoven as well as for purposes of regenerating filters comprising the nonwovens of the invention if their efficiency has dropped during service. The differential pressure and the filtration efficiency was measured with a Palas MFP 3000 test rig at a flow-through speed of 0.1 m/s. The measuring surface was 100 cm²; DEHS was used as aerosol. The quality factor was calculated according to the formula

Quality factor=−ln(DEHS penetration/100))/differential pressure in mm H₂O.

Each of the measurements was performed on the same nonwovens with and without ultrasound finishing (sonication). Ultrasound finishing increased the quality factors of all the nonwovens tested by a factor of 50 to 100.

TABLE 5

| | | Filtration | | Filtration | Quality |
|---|---|---|---|---|---|
| | | efficiency | | efficiency | factor** |
| | Differential | (@0.4 μm) | Quality | (@0.4 μm) | after |
| Sample | pressure | [%] | factor** | [%] after | sonica- |
| no. | [mm H₂O] | untreated | untreated | sonication | tion |
| 1 | 4.4 | 50.1 | 0.009 | 94.5 | 0.66 |
| 2 | 5.1 | 62.5 | 0.007 | 96.1 | 0.64 |
| 3 | 4.9 | 59.2 | 0.008 | 96.8 | 0.70 |
| 4 | 4.2 | 48.0 | 0.009 | 91.7 | 0.59 |
| 5 | 4.8 | 65.1 | 0.007 | 87.0 | 0.43 |
| 6 | 5.0 | 63.7 | 0.007 | 97.4 | 0.73 |
| Average | 4.7 | 58.1 | 0.008 | 93.4 | 0.62 |

List of reference numerals

| | |
|---|---|
| 1 | Biax multirow die |
| 2 | First polymer |
| 3 | Second polymer |
| 4 | Polymer feed line |
| 5 | Duct with capillaries |
| 6 | Hot compressed air |
| 7 | Outlet for high-speed blowing air |
| 8 | High-speed blowing air (coaxial) |
| 9 | Collecting drum |
| 10 | Exxon die |
| 11 | Co-mingling point |
| 12 | Solution-blow die |
| 13 | First die |
| 14 | Second die |
| A, B, C | Axes of the second die |
| D | Axis of the first die |
| q | Tilt angle between the axis of the first die and the axes of |
| | the second die |

1. A method for producing a textile object having electrostatically charged fibres, comprising:
spinning a first polymer to fibres of a first fibre type using a first die and at least one second polymer to fibres of a second fibre type using at least one second die, wherein the fibres are spun using a melt spinning process and/or using a solvent spinning process, or
spinning a first polymer to fibres of a first fibre type and at least one second polymer to fibres of a second fibre type using at least one multipolymer die, wherein the fibres are spun using a melt spinning process and/or using a solvent spinning process,
selecting the first polymer and the at least one second polymer such that the fibres produced from the first polymer can be so strongly charged triboelectrically by frictional interaction with the fibres produced from the at least one second polymer that a filter with a quality factor in excess of 0.2 can be manufactured with the textile object,
shaping the textile object, wherein the frictional interaction occurs before and/or during shaping of the textile object, and/or
inducing the frictional interaction during a finishing process,
wherein, the first polymer and/or the at least one second polymer, contains at least one additive capable of binding free radicals and/or acting as internal slip agent.

2. The method according to claim 1, further comprising spinning the fibres of one fibre type and the fibres of at least one other fibre type such that the fibres of the one fibre type have a larger average fibre diameter than the fibres of the at least one other fibre type.

3. The method according to claim 1, wherein, one fibre type has a smaller average fibre diameter than at least one other fibre type, and the first or at least one second polymer used to form the one fibre type contains the at least one additive capable of binding free radicals and/or the additive capable of acting as an internal slip agent.

4. The method according to claim 1, further comprising spinning the fibres of the first fibre type and the fibres of the at least one second fibre type such that the fibres of the first fibre type have a larger average fibre diameter than the fibres of the at least one second fibre type.

5. The method according to claim 1, wherein at least the first die has concentric orifices.

6. The method according to claim 1 further comprising mechanically treating the textile object after it has been shaped such that the fibres of the textile object rub against one another.

7. The method according to claim 1, further comprising charging the textile object triboelectrically after it has been shaped using sonic or ultrasonic irradiation.

8. The method according to claim 7, wherein, the sonic or ultrasonic irradiation contains at least one frequency within the range from 1 kHz to 100 kHz.

9. The method according to claim 1, further comprising triboelectrically charging the textile object after it has been shaped by passing gases or vapours through it.

10. The method according to claim 2, further comprising mixing, before and/or during shaping of the textile object, the fibres of the one fibre type with the fibres of the at least one other fibre type such that, at least in a partial volume of the textile object, the proportions of the fibres of the one fibre type and of the fibres of the at least one other fibre type exhibit a gradient over a cross section of the textile object.

11. The method according to claim 2, wherein the first or at least one second polymer used to form fibres of the one fibre type has a melt flow index of less than 800.

12. The method according to claim 2, wherein the first or the at least one second die used for the production of fibres of the at least one other fibre type has concentric orifices, and the first or the at least one second polymer used to form the at least one other fibre type has a melt flow index of less than 2000, or further comprising spinning a polymer solution.

13. The method according to claim 2, wherein the first or the at least one second die used for the production of fibres of the at least one other fibre type has Exxon-type orifices, and the first or the at least one second polymer used to form the at least one other fibre type has a melt flow index of greater than 300.

14. The method according to claim 1, wherein at least one of the first and the at least one second polymers comprise polypropylene, polyactide, polyamide, polystyrene, polyvinyl chloride or a blend of these polymers.

15. The method according to any claim 1, wherein at least one of the first and the at least one second polymers comprise nylon, polyurethane, cellulose, polycarbonate, an artificial resin, polybutylene terephthalate, polyethylene terephthalate, PVDF POM, PEEK, PAN, PMMA, melamine or a blend of these polymers.

16. The method according to claim 1, further comprising adding super-fine fibres having an average fibre diameter of less than 1 μm to the fibres of the first fibre type and to the fibres of the second fibre type before and/or during shaping of the textile object using a collecting device.

17. A textile object comprising:
first fibres of a first fibre type, which are formed from a first polymer, and
second fibres of at least one second fibre type, which the are formed from at least one second polymer, which differs from the first polymer, wherein the first and second fibres are spun by a melt spinning process and/or by a solvent spinning process,
wherein the first fibres produced from the first polymer and/or the second fibres produced from the at least one second polymer are so strongly charged triboelectrically by frictional interaction occurring before and/or during shaping of the textile object and/or by frictional interaction occurring during a finishing process that the textile object can be used to manufacture filters with quality factors in excess of 0.2,
wherein the first polymer and/or the at least one second polymer contains at least one additive capable of binding free radicals and/or contains an additive capable of acting as an internal slip agent.

18. The textile object according to claim 17, wherein the first fibres of the first fibre type have an average fibre diameter of greater than 7 μm.

19. The textile object according to claim 17, wherein the second fibres of the at least one second fibre type have an average fibre diameter of smaller than 7 μm.

20. A filter element constructed with a textile object produced with the method according to claim 1.
